(19) United States
(12) Patent Application Publication
(10) Pub. No.: US 2021/0061402 A1
(43) Pub. Date: Mar. 4, 2021

(54) Racing Bicycle Handlebar

(71) Applicant: Canyon Bicycles GmbH, Koblenz (DE)

(72) Inventors: Lars Wagner, Muehltal (DE); Daniel Heyder, Alfter (DE); Fedja Delic, Wuppertal (DE)

(21) Appl. No.: 17/004,148

(22) Filed: Aug. 27, 2020

(30) Foreign Application Priority Data
Aug. 28, 2019 (DE) 20 2019 104 712.7

(51) Int. Cl. B62K 21/12; B62K 21/26; B62K 23/06; B62L 3/02

(52) U.S. Cl. CPC B62K 21/125; B62K 21/26; B62K 21/14; B62L 3/02; B62K 23/06

(57) ABSTRACT

A racing bicycle handlebar includes a transverse support connected to a handlebar stem or integrally formed therewith. Two arcuate lower handle elements are connected to the transverse support. The connection is established by a connecting element respectively arranged between the transverse support and the respective handle element. In addition to clamping areas for fastening brake lever units, the connecting elements also includes gripping areas. The gripping areas are arranged between the clamping areas and the transverse support in order to improve ergonomics or prevent pressure marks, wherein in particular an upper side is provided with a smaller curvature or flattening, respectively.

### CROSS-REFERENCE TO RELATED APPLICATION

This application claims priority to German Patent Application No. 20 2019 104 712.7 filed Aug. 28, 2019, the disclosure of which is hereby incorporated by reference in its entirety.

### BACKGROUND OF THE INVENTION

### Field of the Invention

The disclosure relates to a racing bicycle handlebar.

### Description of Related Art

Conventional bicycle handlebars for racing bicycles comprise a transverse support connected to the handlebar stem or formed integrally with the same. The handlebar stem is connected to a steer tube or formed integrally with the same. Lower handle elements are arranged at the two outer sides of the transverse support of the racing bicycle handlebar. Said lower elements are of an arcuate and in particular of a substantially semi-circular design in side view. Such racing bicycle handlebars may be held in particular in three different gripping positions. On the one hand, it is possible to grip the handlebar at the lower handle elements. The lower handle elements are especially gripped in sprint. In more relaxed riding positions, the transverse support or an area of a connecting element between the transverse support and the handle element is gripped. The connecting element is the area of the racing bicycle handlebar in which the transverse support is angled forward by 90° and then merges with the lower handle elements. At the connecting elements brake lever units are fastened, in particular clampingly, which are often a combination of shift lever and brake lever. Gripping is often carried out in conjunction with a rear contact surface of the brake lever units, so that the ball of the thumb is located in a gripping area of the connecting element. The gripping area is thus arranged between the clamping area for the brake lever unit and the transverse support. This is a gripping position which is often chosen by users. In this gripping position, which is called shifter position, pressure marks often occur on the palms.

It is an object of the disclosure to create a bicycle handlebar which is designed more comfortable in the gripping area, e.g. particularly in the shifter position, so that the occurrence of pressure marks is reduced.

The object is achieved according to this disclosure by a racing bicycle handlebar.

The racing bicycle handlebar according to the disclosure comprises a transverse support connected to the handlebar stem or formed integrally with the same. Two arcuate handle elements for a lower gripping position are arranged at the side of the transverse support. The two handle elements are each connected via connecting elements or transverse supports, respectively. The transverse support, the connecting elements and the handle elements are preferably formed integrally, wherein optionally the handlebar stem is additionally formed integrally therewith. Each connecting element comprises a clamping area. The clamping areas serve for particularly clampingly fastening respectively one brake lever unit, wherein a shifter unit can be integrated in the brake lever unit.

The connecting elements further comprise between the clamping areas and the transverse support respectively one gripping area. This gripping area is arranged in direction of travel behind the clamping area. In the mounted state of the brake lever unit, gripping of the racing bicycle handlebar in the gripping area is often carried out together with a rear contact area of the brake lever units facing against the direction of travel.

According to the disclosure, the gripping areas each comprise a non-circular cross-section. Such a non-circular design of the gripping area makes it possible to ergonomically adjust the gripping area. In this way, in particular ergonomically designed support surfaces for the ball of the thumb can be provided in this area such that the risk of pressure marks is reduced. In this way, it is also possible, in particular, to enlarge the support surface and to thus reduce the surface pressure. Due to the enlarged surface, the pressure is distributed more, so that the risk of the occurrence of pressure marks is also reduced thereby.

Preferably, an upper side of the gripping area is designed such that the gripping area has a smaller curvature than the side areas of the gripping area. The deviating curvature extends in circumferential direction or substantially transversely to the direction of travel, respectively, in case of a mounted racing bicycle handlebar. If the racing bicycle handlebar is mounted, the upper side of the gripping area faces upwards. The palm and in particular the area of the palm merging into the thumb is supported on the upper side of the gripping area. The occurrence of pressure marks can be reduced by the, compared to the side areas, smaller curvature or flattening of the upper side. It is particularly preferred that the gripping area in plan view, i.e. in the mounted state of the bicycle handlebar, has a larger width from above than the clamping area. Due to the widening of the bicycle handlebar in the gripping areas, an enlargement of the surface and thus a better pressure distribution can be achieved.

The clamping area preferably has a circular cross-section, so that conventional brake lever units can be connected as usual with the racing bicycle handlebar according to the disclosure, wherein a non-circular cross-section of the clamping area, for example for special designs of the brake lever unit, is also possible.

Preferably, the transition between the gripping area and the clamping area is at least partially step-shaped. In a preferred embodiment, the step is formed such that a step facing downward is provided at the upper side of the gripping area in a mounted state of the bicycle handlebar. If the brake lever unit is additionally mounted, the mounting is preferably carried out such that the step is reduced or, in a preferred embodiment, compensated, so that a particularly stepless transition between the upper side of the gripping area to an upper side of the brake lever unit is occurs. In a preferred embodiment, the step is arranged at least in the area of the upper side between the gripping area and the clamping area. It is also preferred in the two opposite side areas to provide a step which optionally has a smaller height than the step provided at the upper side. A step can also be provided in the lower area, wherein preferably a stepless transition between the lower side of the gripping area and the clamping area occurs.

In a further particularly preferred embodiment, the gripping area is designed such that the upper side of the gripping area is convex-shaped in longitudinal direction or in the mounted state of the bicycle handlebar in the direction of travel. Thus, the upper side is convex in side view. This upward curvature or bulge can in turn improve ergonomics and thus reduce the occurrence of pressure marks.

It is further preferred that the cross-section of the connecting element in the gripping area increases towards the clamping area. In the mounted state it is thus particularly preferred that the upper side of the gripping area is formed horizontally, tentatively slightly increasing. This is how the ergonomics of the gripping area can also be improved.

In a further particularly preferred embodiment, a rear edge of the connecting element is further developed in an advantageous manner. The rear edge of the connecting element is the edge or the area with a strong curvature which faces against the direction of travel towards the user. In a preferred embodiment, such an edge is inclined downwards starting from the transverse support. If the bicycle handlebar is mounted, this edge extends from inside falling to the outside when looking at the rear side of the connecting element, e.g., when looking in the direction of travel. This causes a significant improvement in ergonomics.

The disclosure further relates to a racing bicycle handlebar system comprising a racing bicycle handlebar which is designed and further developed in an advantageous manner as described above. The racing bicycle handlebar system further comprises two bake lever units each fastened in the clamping area of the racing bicycle handlebar. In this preferred embodiment of the racing bicycle handlebar system, the brake lever units as well as the step between the gripping area and the clamping area are designed such that in a mounted state a substantially stepless transition from the upper side of the gripping area to the upper side of the brake lever unit is given.

### BRIEF DESCRIPTION OF THE DRAWINGS

In the following, the disclosure is explained in more detail by means of a preferred embodiment with reference to the attached drawings, in which:

FIG. 1 shows a schematic side view of a bicycle handlebar according to the disclosure,

FIG. 2 shows a schematic side view of the bicycle handlebar corresponding to FIG. 1 together with a schematically illustrated brake lever unit,

FIG. 3 shows a schematic plan view of a bicycle handlebar,

FIG. 4 shows a schematic rear view of the bicycle handlebar,

FIG. 5 shows a schematic side view along the line V-V in FIG. 4, and

FIGS. 6A-6D shows different sectional views of the area correspondingly designated in FIG. 3.

### DESCRIPTION OF THE INVENTION

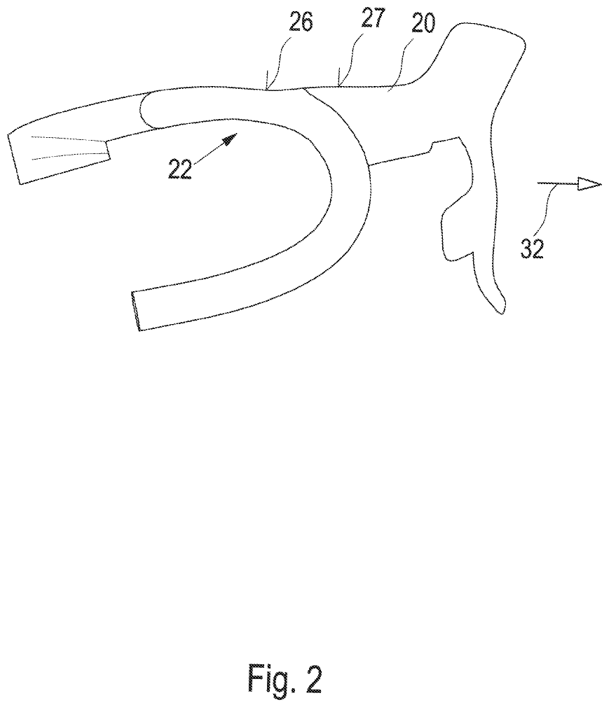

The illustrated particularly preferred embodiment of the bicycle handlebar according to the disclosure comprises a transverse support 10 formed integrally with a handlebar stem 12 in the illustrated exemplary embodiment. A connecting element 14 is arranged integrally with transverse support 10 on both sides or is connected to the transverse support. The connecting element 14 serves for connecting transverse support 10 with the two lower handle elements 16 with an arcuate design in side view. The two connecting elements 14 each comprise a clamping area 18 with a preferably circular cross-section. In the clamping are, a brake lever unit 20 (FIG. 2) can be fastened, in particular clampingly.

Between clamping area 18 and transverse support 10, the connecting elements comprise a gripping area 22. Between gripping area 22 and clamping area 18, a step 24 is provided. The step 24 connects to an upper side 26 of gripping area 22. The step 24 is further provided in side areas 28. At a lower side 30, the transition between gripping area 22 and clamping area 18 is stepless in the illustrated embodiment. If the brake lever unit 20 is additionally mounted, the mounting is preferably carried out such that the step is reduced or, in a preferred embodiment, compensated, so that a particularly stepless transition between the upper side 26 of the gripping area 22 to an upper side 27 of the brake lever unit 20 occurs.

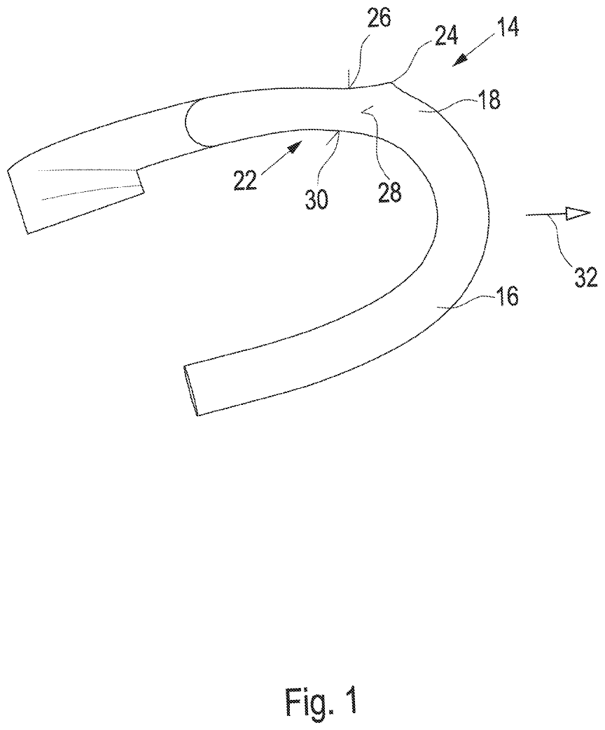

As can be seen particularly in the side view (FIGS. 1 and 2), upper side 26 of gripping area 22 is formed to be convexly curved in the direction of travel 32.

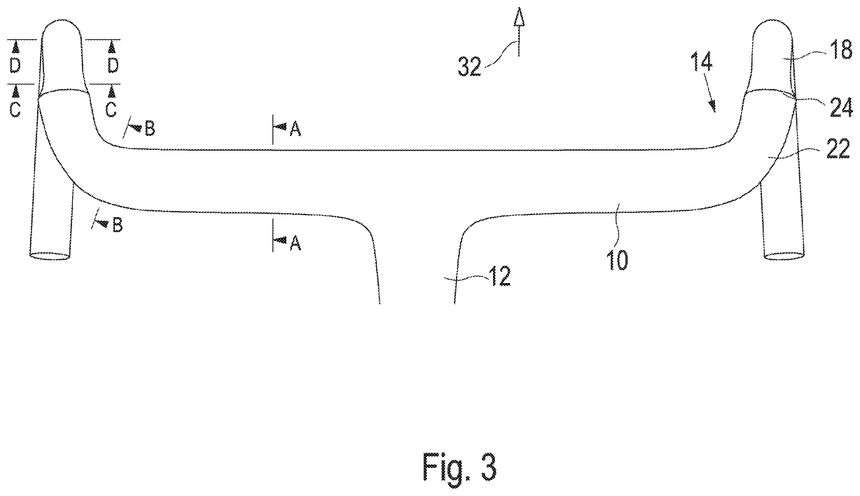

The gripping area 22 with a non-circular cross-section has a larger width than clamping area 18 in plan view (FIG. 3), in particular near step 24, transversely to the longitudinal direction or the direction of travel 32. Particularly in the transition area between transverse support 10 and connecting element 14, the width of connecting element 14 extending in longitudinal direction (identical to the direction of travel 32) is significantly wider than in clamping area 18. Thus, an extensive upper side 26 is designed which prevents the occurrence of pressure marks.

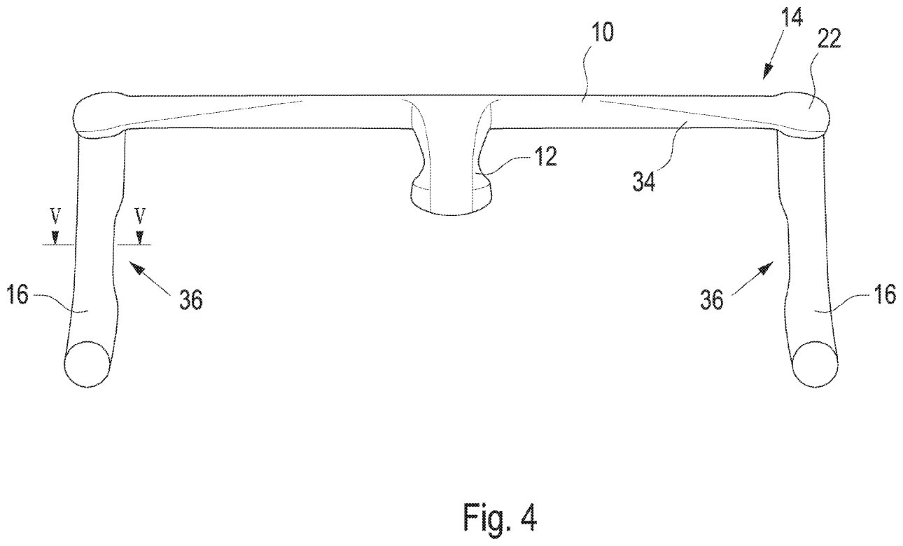

It can be seen from the rear view (FIG. 4) that an edge 34 of the connecting element is adapted to incline or fall to the outside. The edge 34 is formed by the area of a strong curvature on the rear side of connecting element 14. The edge 34 extends in a preferred embodiment into the area of transverse support 10. Particularly through such a design, a thumb rest can be created in area 36. Such a thumb rest serves for an ergonomic hand position and for an ergonomic support of the hand. Thus, a more comfortable and fatigue-free hand position is achieved.

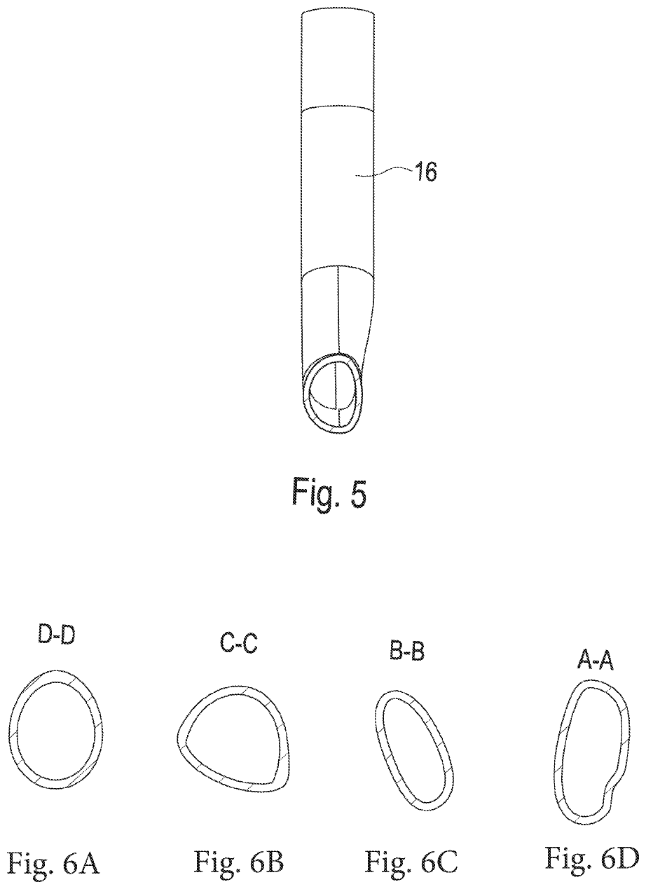

FIGS. 5 and 6A-6D show the different cross-sectional areas. This further illustrates the, according to the disclosure, advantageous design of the cross-sections.

1. A racing bicycle handlebar, comprising
a transverse support connectable with a handlebar stem,
two arcuate handle elements being arranged on a side of the transverse support, and
two connecting elements, each connecting the transverse support with one of the two handle elements,
wherein each connecting element comprises a clamping area for fastening a brake lever unit and a gripping area arranged between the clamping area and the transverse support,
wherein
the gripping area has a non-circular cross-section.

2. The racing bicycle handlebar according to claim 1, wherein an upper side of the gripping area comprises a smaller curvature than side areas of the gripping area.

3. The racing bicycle handlebar according to claim 1, wherein the gripping area is wider than the clamping area in plan view.

4. The racing bicycle handlebar according to claim 1, wherein the transition between the gripping area and the clamping area is at least partially step-shaped.

5. The racing bicycle handlebar according to claim 1, wherein the clamping area has a circular cross-section.

6. The racing bicycle handlebar according to claim 1, wherein the gripping area is convex-shaped at an upper side in longitudinal direction.

7. The racing bicycle handlebar according to claim 1, wherein a cross-section of the connecting element increases in the gripping area towards the clamping area.

8. The racing bicycle handlebar according to claim 1, wherein the connecting element comprises a rear edge facing away from the clamping area which rear edge is inclined downwards in a mounted state starting from the transverse support.

9. A racing bicycle handlebar system comprising a racing bicycle handlebar according to claim 1 and brake lever units fastened in the clamping areas, wherein the upper sides of the gripping areas merge steplessly into an upper side of the brake lever unit.
